(19) United States
(12) Patent Application Publication
(10) Pub. No.: US 2013/0282172 A1
(43) Pub. Date: Oct. 24, 2013

(54) AUTOMATIC LIQUID SUPPLY SYSTEM

(71) Applicant: Cheng-Feng Chen, New Taipei (TW)

(72) Inventor: Cheng-Feng Chen, New Taipei (TW)

(73) Assignee: Bobson Hygiene International, Inc., New Taipei City (TW)

(21) Appl. No.: 13/451,109

(22) Filed: Apr. 19, 2012

(51) Int. Cl. G06F 17/00

(52) U.S. Cl. 700/237

(57) ABSTRACT

An automatic liquid supply system includes an assembly of a storage component and a pump device operable to allow liquid flow out of the storage component, an installation component for installing the assembly, an RFID tag that records an authentication code and that is disposed on the assembly, a storage unit storing qualified authentication codes, a transmission unit controlling the pump device, and a control unit. The control unit controls the transmission unit to activate the pump device to allow the liquid flow when the control unit determines that the authentication code matches one of the qualified authentication codes.

### BACKGROUND OF THE INVENTION

1. Field of the Invention

The invention relates to an automatic liquid supply system, and more particularly to an automatic liquid supply system that is capable of authentication.

2. Description of the Related Art

A user may touch and press a bottle container using a dirty hand, to thereby result in germ residue and contamination. To solve this problem, an automatic liquid supply device is available.

Referring to FIG. 1 and FIG. 2, a conventional automatic liquid supply device 1 includes a housing 11, a storage component 12 disposed in the housing 11 for accommodating a liquid and having an opening 121, a sensor 13, a control unit 15 receiving power from a power source 14 and electrically coupled to the sensor 13, a transmission unit 16 coupled to the control unit 15, and a pump unit 17 disposed within the opening 121 of the storage component 12 and connected to the transmission unit 16. The transmission unit 16 includes a plurality of gears 161 and a rack 162 activated by one of the gears 161. The pump unit 17 is activated by the rack 162.

The sensor 13 sends a trigger signal to the control unit 15 upon detecting approach of an object, and the control unit 15 provides a control command to the transmission unit 16, so that the transmission unit 16 is operable to control the pump unit 17 to allow the liquid to flow out of the storage component 12 for a specific time period.

When the storage component 12 is emptied, the storage component 12 or an assembly of the storage component 12 and the pump unit 17 may be replaced with a new one filled with the liquid and provided by the original vendor for quality control. Another option is to purchase and fill the liquid into the storage component 12, but quality may not be guaranteed.

### SUMMARY OF THE INVENTION

Therefore, an object of the present invention is to provide an automatic liquid supply system that is operable to authenticate an assembly of a storage component and a pump unit for guaranteeing liquid quality.

According to the present invention, an automatic liquid supply system comprises:

a storage component having an internal space adapted for containing a liquid, and an opening;

a pump device being disposed within the opening of the storage component, and having an internal passage in spatial communication with the internal space of the storage device, the pump device being operable to allow the liquid in the internal space to flow out of the storage component through the internal passage;

an installation component for installing the storage component and the pump device thereon;

an authentication unit including a radio frequency identification (RFID) tag that is disposed on one of the storage component and the pump device, and that records an authentication code, and a reader installed on the installation component, the reader receiving a tag signal from the RFID tag and generating a sensing signal containing the authentication code when the RFID tag is disposed proximate to the reader;

a storage unit storing a plurality of qualified authentication codes;

a transmission unit operable to control the pump device to allow the liquid in the internal space to flow through the internal passage; and

a control unit electrically coupled to the authentication unit, the storage unit, and the transmission unit, the control unit receiving the sensing signal from the reader, and comparing the authentication code contained in the sensing signal with the qualified authentication codes in the storage unit.

The control unit controls the transmission unit to activate the pump device to allow the liquid in the internal space to flow through the internal passage when the control unit determines that the authentication code contained in the sensing signal matches one of the qualified authentication codes in the storage unit.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional automatic liquid supply device;

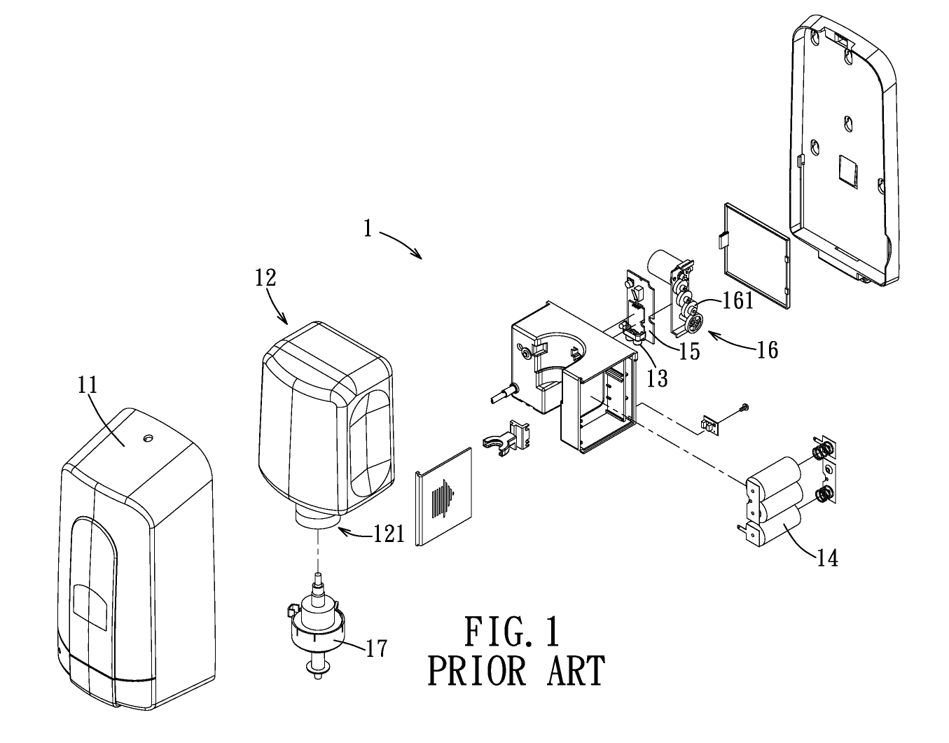

FIG. 2 is a sectional view of the conventional automatic liquid supply device;

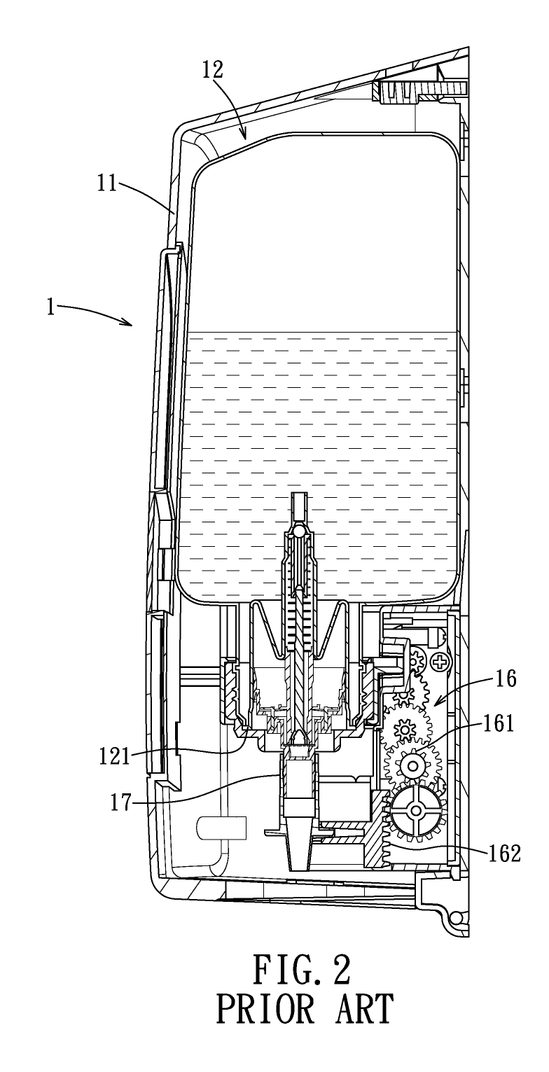

FIG. 3 is an exploded perspective view of the preferred embodiment of an automatic liquid supply system according to the present invention;

FIG. 4 is a block diagram of the preferred embodiment;

FIG. 5 is a rear perspective view showing a circuit board and a transmission unit installed on an installation component;

FIG. 6 is a sectional view of the preferred embodiment;

FIG. 7 is a partly exploded perspective view illustrating a relationship between a pump device and the installation component; and

FIG. 8 is a flow chart to illustrate operation of the preferred embodiment.

### DETAILED DESCRIPTION OF THE PREFERRED EMBODIMENT

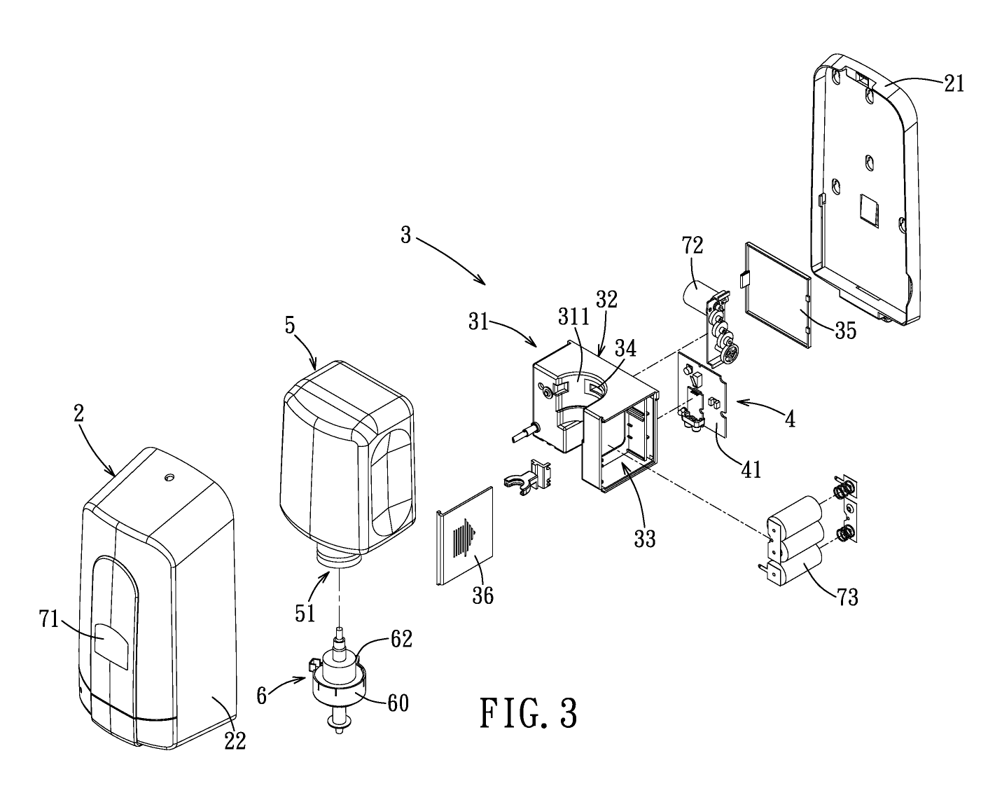

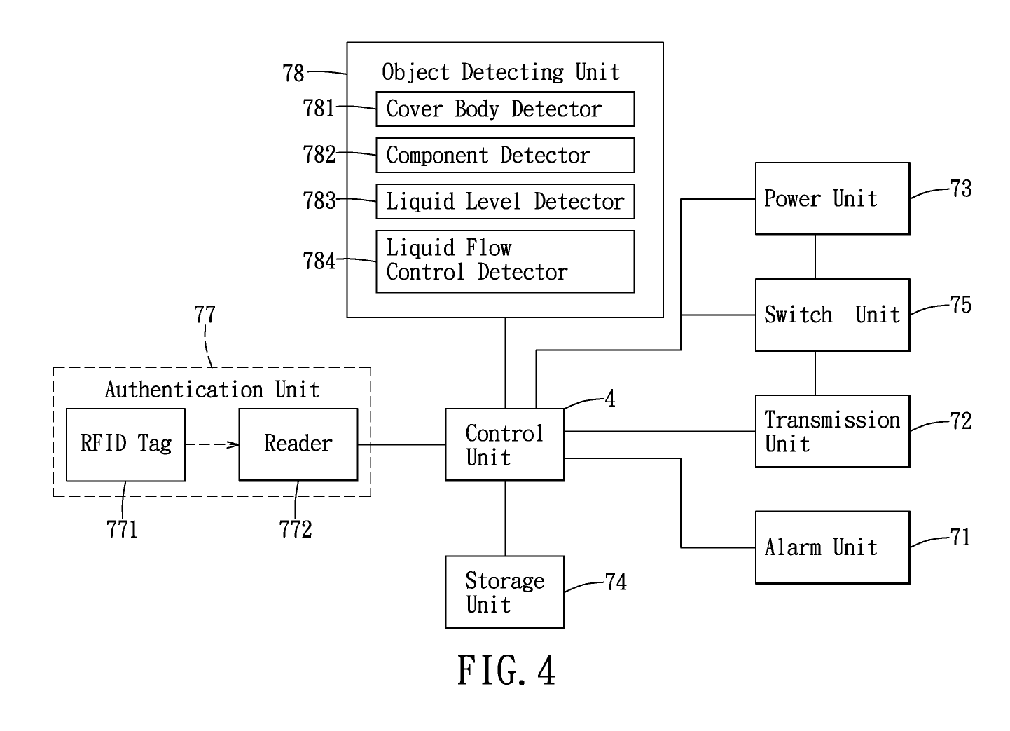

Referring to FIG. 3 and FIG. 4, the preferred embodiment of the automatic liquid supply system according to this invention is adapted to be installed in a bathroom, a toilet, or a place that requires liquid dispensing. The preferred embodiment is exemplified by but not limited to a dispenser for dispensing a cleaner, such as a hand cleaner, an alcohol, etc., upon detection of a user's hand. In other applications, the present invention may be applied to regularly spray a liquid medicine or a fragrance. The automatic liquid supply system comprises a housing 2, an installation component 3, a control unit 4, a storage component 5, a pump device 6, an alarm unit 71, a transmission unit 72, a power unit 73, a storage unit 74, a switch unit 75, and an object detecting unit 78. The alarm unit 71, the transmission unit 72, the power unit 73, the storage unit 74, the switch unit 75, and the object detecting unit 78 are electrically coupled to the control unit 4.

The automatic liquid supply system further comprises an authentication unit 77 for automatically authenticating the storage component 5 and the pump device 6 that are installed on the installation component 3.

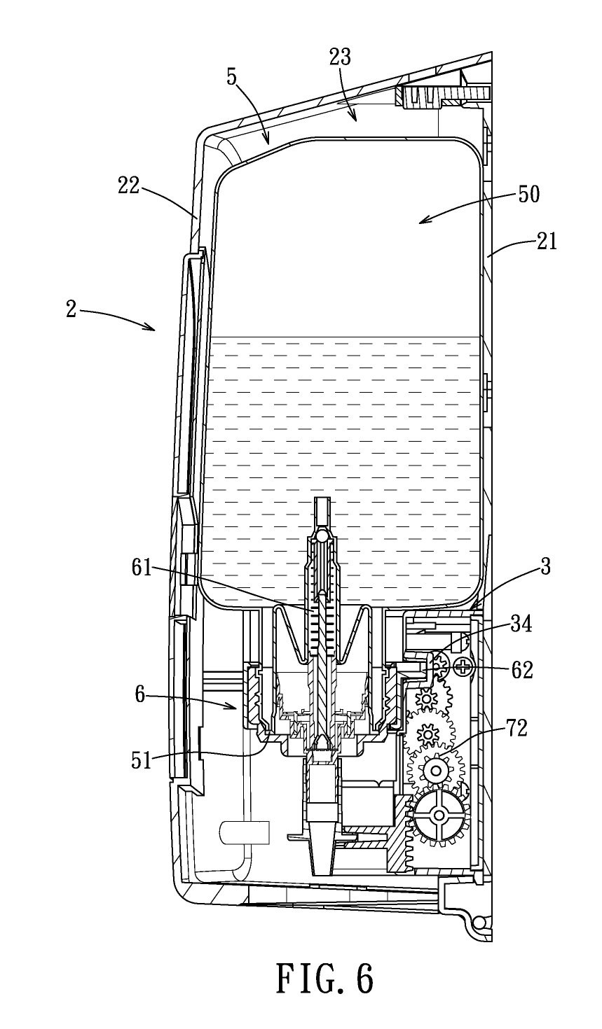

Further referring to FIG. 6, the housing 2 includes a shell body 21 to be fixed on a wall surface (not shown) , and a cover body 22 assembled with the shell body 21. The shell body 21 and the cover body 22 define an accommodating space 23 therebetween. In this embodiment, the alarm unit 71 includes but is not limited to a display panel disposed on the cover body 22, and is operable to display a notification or provide a flashing indication when receiving an alarm signal from the control unit 4. The alarm unit 71 can also be a buzzer for audible output of a warning sound.

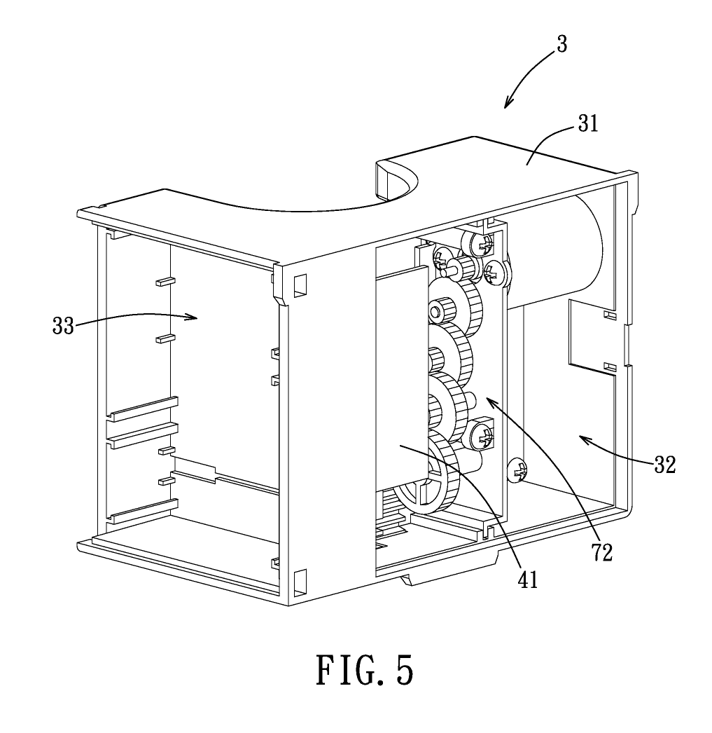

Referring to FIG. 3 to FIG. 6, the installation component 3 is disposed in the accommodating space 23 and is proximate to the shell body 21. The installation component 3 includes a base 31 being of a forwardly opening U shape defining a gap 311, a first chamber 32 concavely formed at a back surface of the base 31, a second chamber 33 formed at a side of the base 31, a reader groove 34 concavely formed in a surface of the base 31 defining the gap 311, a first cover plate 35 removably covering the first chamber 32, and a second cover plate 36 removably covering the second chamber 33. The control unit 4 includes a circuit board 41. The circuit board 41 and the transmission unit 72 are disposed in the first chamber 32, and the power unit is disposed in the second chamber 33. In this embodiment, the transmission unit 72 is formed of a motor and a gear set, and the power unit 73 is a battery set. The storage unit 74 and the switch unit 75 are disposed on the circuit board 41.

In detail, the switch unit 75 is further electrically coupled to the transmission unit 72 and the power unit 73, such that the switch unit 75 is operable by the control unit 4 to allow power to be supplied from the power unit 73 to the transmission unit 72 . The storage unit 74 stores data, such as a plurality of qualified authentication codes and a usage number of the automatic liquid supply system.

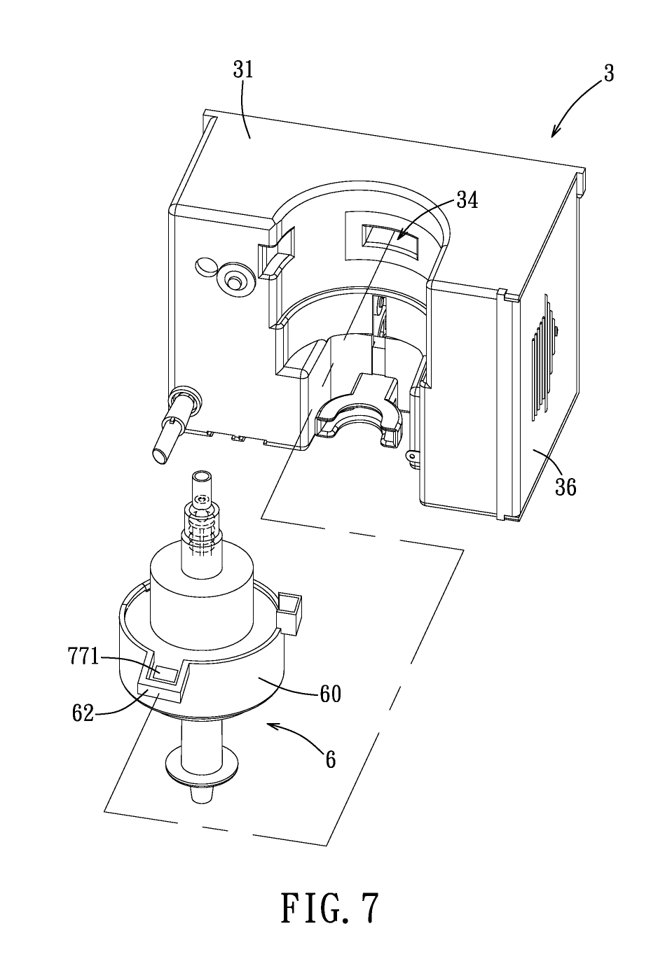

Further referring to FIGS. 6 and 7, the storage component 5 has an internal space 50 adapted for containing a liquid, and an opening 51. The pump device 6 is disposed within the opening 51 of the storage component 5, and the assembly of the pump device 6 and the storage component 5 is installed on the installation component 3. The pump device 6 has a pump body 60, an internal passage 61 in spatial communication with the internal space 50 of the storage component 5, and a protrusion 62 radially protruding from the pump body 60. The pump device 6 is operable to allow the liquid in the internal space 50 to flow out of the storage component 5 through the internal passage 61.

The authentication unit 77 includes a radio frequency identification (RFID) tag 771 that is disposed on one of the storage component 5 and the pump device 6, and that records an authentication code, and a reader 772 installed on the installation component 3. The reader 772 receives a tag signal from the RFID tag 771 and generates a sensing signal containing the authentication code when the RFID tag 771 is disposed proximate to the reader 772. In this embodiment, the RFID tag 771 is disposed on the protrusion 62 of the pump device 6. When the pump device 6 is installed on the installation component 3, the protrusion 62 is engaged within the reader groove 34. The reader 772 has a sensing coil (not shown) that is disposed on the circuit board 41 and that is aligned with the reader groove 34. In other embodiments, the RFID tag 771 may be disposed on any surface of the storage component 5, as long as the reader 772 can receive the sensing signal from the RFID tag 771.

The object detecting unit 78 includes a cover body detector 781, a component detector 782, a liquid level detector 783, and a liquid flow control detector 784. In this embodiment, the cover body detector 781, the component detector 782, and the liquid level detector 783 are disposed in the installation component 3, and are electrically coupled to the circuit board 41. The liquid flow control detector 784 is an infrared sensor. The cover body detector 781 is operable to provide the alarm signal to the control unit 4 when the cover body 22 is removed from the shell body 21, and the component detector 782 is operable to provide the alarm signal to the control unit 4 when the storage component 5 and the pump device 6 are removed from the installation component 3, such that the control unit 4 is operable to control the switch unit 75 to disable supply of power from the power unit 73 and thereby deactivate the transmission unit 72, and is operable to control the alarm unit 71 to issue the notification. The liquid level detector 783 is operable to provide the alarm signal to the control unit 4 when the amount of the liquid remaining in the storage component 5 is less than a predetermined value, such that the control unit 4 is operable to control the alarm unit 71 to issue the notification. The liquid flow control detector 784 is operable to provide a trigger signal to the control unit 4 upon detecting approach of an object (such as a user's hand), such that the control unit 4 is operable to control the pump device 6 to allow a predetermined amount of the liquid in the internal space 50 to flow out of the storage component 5 through the internal passage 61. In this invention, the cover body detector 781, the component detector 782, the liquid level detector 783, and the liquid flow control detector 784 are not limited to specific types and are not limited to be disposed on specific positions.

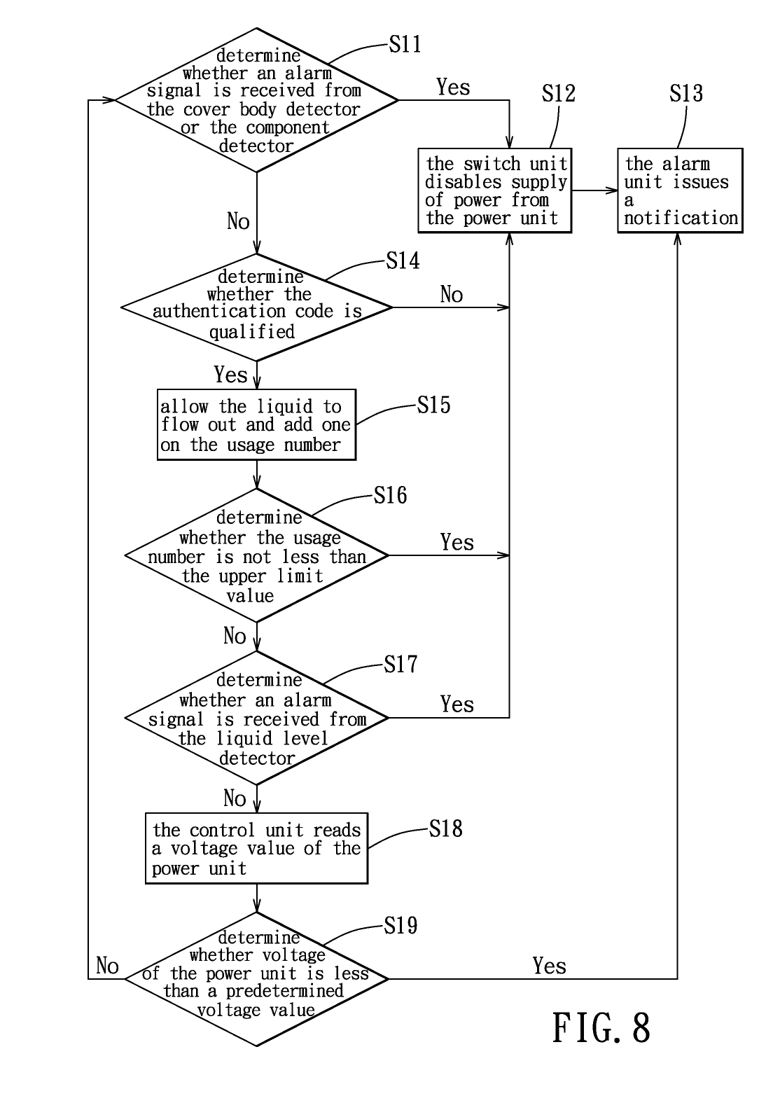

Referring to FIG. 8, operation of the automatic liquid supply system of this embodiment includes the following steps.

Step S11: The control unit 4 determines whether an alarm signal is received from the cover body detector 781 or the component detector 782. When the determination is affirmative, the flow goes to step S12. Otherwise, the flow goes to step S14.

Step S12: The control unit 4 controls the switch unit 75 to disable supply of power from the power unit 73 and thereby deactivate the transmission unit 72, and the flow goes to step S13. This step can save the power consumption.

Step S13: The control unit 4 controls the alarm unit 71 to issue a notification through the display panel or provide a flashing indication for warning purposes.

Step S14: The control unit 4 receives the sensing signal from the reader 772 containing an authentication code, and compares the authentication code with the qualified authentication codes in the storage unit 5. When the control unit 4 determines that the authentication code contained in the sensing signal matches one of the qualified authentication codes, the flow goes to step S15. Otherwise, the flow goes to step S12.

In detail, when an assembly of the storage component 5 and the pump device 6 is produced, a corresponding RFID tag 771 is provided thereon. The RFID tag 771 corresponds to an authentication code that represents the assembly of the storage component 5 and the pump device 6. The content of the authentication code may include property parameters of the liquid contained in the storage component 5, the production serial number, etc. Therefore, when the control unit 4 compares the authentication code with the qualified authentication codes in the storage unit 5, it also confirms whether the content in the storage component 5 is a qualified liquid. In addition, the storage unit 74 maybe operable to disqualify the matched one of the qualified authentication codes from future use, such that when the control unit 4 determines that the authentication code contained in the sensing signal has been disqualified, the flow goes to step S12 to thereby prevent an unknown liquid from being refilled into the storage component 5, so that quality of the liquid in the storage component 5 may be guaranteed.

Step S15: The control unit 4 activates the transmission unit 72 to control the pump device 6 to allow the liquid in the internal space 50 to flow out of the storage component 5 through the internal passage 61 upon detecting approach of a user's hand, and adds one on the usage number stored in the storage unit 74 upon each activation of the transmission unit 72. Then, the flow goes to step S16.

Step S16: The control unit 4 compares the usage number with an upper limit value. When the control unit 4 determines that the usage number is not less than the upper limit value, the flow goes to step S12. Otherwise, the flow goes to step S17.

Step S17: The control unit 4 determines whether an alarm signal is received from the liquid level detector 783. When the determination is affirmative, the flow goes to step S12. Otherwise, the flow goes to step S18.

Step S18: The control unit 4 reads a voltage value of the power unit 73, and the flow goes to step S19.

Step 19: The control unit 4 determines whether voltage of the power unit 73 is less than a predetermined voltage value. When the determination is affirmative, the flow goes to step S13. Otherwise, the flow goes back to step S11.

To sum up, liquid flow is allowed in the present invention only when the control unit 4 determines the authentication code of the RFID tag 771 provided on the assembly of the storage component 5 and the pump device is a qualified authentication code, to thereby guarantee the quality of liquid contained in the storage component 5.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An automatic liquid supply system comprising:
a storage component having an internal space adapted for containing a liquid, and an opening;
a pump device being disposed within said opening of said storage component, and having an internal pas sage in spatial communication with said internal space of said storage component, said pump device being operable to allow the liquid in said internal space to flow out of said storage component through said internal passage;
an installation component for installing said storage component and said pump device thereon;
an authentication unit including a radio frequency identification (RFID) tag that is disposed on one of said storage component and said pump device, and that records an authentication code, and a reader installed on said installation component, said reader receiving a tag signal from said RFID tag and generating a sensing signal containing said authentication code when said RFID tag is disposed proximate to said reader;
a storage unit storing a plurality of qualified authentication codes;
a transmission unit operable to control said pump device to allow the liquid in said internal space to flow through said internal passage; and
a control unit electrically coupled to said authentication unit, said storage unit, and said transmission unit, said control unit receiving the sensing signal from said reader, and comparing said authentication code contained in the sensing signal with said qualified authentication codes in said storage unit;
wherein said control unit controls said transmission unit to activate said pump device to allow the liquid in said internal space to flow through said internal passage when said control unit determines that said authentication code contained in the sensing signal matches one of said qualified authentication codes in said storage unit.

2. The automatic liquid supply system as claimed in claim 1, further comprising a switch unit electrically coupled to said control unit and said transmission unit, and a power unit electrically coupled to said switch unit, such that said switch unit is operable to control power supply from said power unit to said transmission unit, said control unit being operable to control said switch unit to allow power to be supplied from said power unit to activate said transmission unit when said control unit determines that said authentication code contained in the sensing signal matches one of said qualified authentication codes in said storage unit, said control unit being operable to control said switch unit to disable supply of power from said power unit and thereby deactivate said transmission unit when said control unit determines that said authentication code contained in the sensing signal does not match any one of said qualified authentication codes in said storage unit.

3. The automatic liquid supply system as claimed in claim 2, wherein said storage unit is operable to disqualify the matched one of said qualified authentication codes from future use, such that said control unit is operable to control said switch unit to disable supply of power from said power unit and thereby deactivate said transmission unit when said control unit determines that said authentication code contained in the sensing signal has been disqualified.

4. The automatic liquid supply system as claimed in claim 2, wherein said storage unit further stores a usage number, said control unit being operable to add one on said usage number stored in said storage unit upon each activation of said transmission unit, said control unit being further operable to compare said usage number with an upper limit value, and to control said switch unit to disable supply of power from said power unit and thereby deactivate said transmission unit when said control unit determines that said usage number is not less than the upper limit value.

5. The automatic liquid supply system as claimed in claim 2, wherein said RFID tag further records a property parameter of the liquid contained in said storage component, said storage unit further storing a plurality of qualified parameters of liquids, the sensing signal further containing said property parameter of the liquid contained in said storage component, said control unit comparing said property parameter contained in the sensing signal with said qualified parameters of liquids stored in said storage unit, and being operable to control said switch unit to disable supply of power from said power unit and thereby deactivate said transmission unit when said control unit determines that said property parameter does not match said qualified parameters stored in said storage unit.

6. The automatic liquid supply system as claimed in claim 2, further comprising an alarm unit electrically coupled to and controlled by said control unit to issue a notification after said control unit receives the sensing signal and deactivates said transmission unit as a result of comparing said authentication code contained in the sensing signal with said qualified authentication codes in said storage unit.

7. The automatic liquid supply system as claimed in claim 6, wherein said control unit is operable to determine whether power of said power unit is less than a power value, and when determination made by said control unit is affirmative, said control unit is further operable to control said alarm unit to issue the notification.

8. The automatic liquid supply system as claimed in claim 2, further comprising an object detecting unit electrically coupled to said control unit, and an alarm unit electrically coupled to and controlled by said control unit, said control unit being operable to control said alarm unit to issue a notification when said control unit receives an alarm signal from said object detecting unit.

9. The automatic liquid supply system as claimed in claim 8, further comprising a shell body, and a cover body assembled with said shell body, said shell body and said cover body defining an accommodating space therebetween for receiving said storage component and said pump device, said object detecting unit including a cover body detector operable to provide the alarm signal to said control unit when said cover body is removed from said shell body, such that said control unit is operable to control said switch unit to disable supply of power from said power unit and thereby deactivate said transmission unit, and is operable to control said alarm unit to issue the notification.

10. The automatic liquid supply system as claimed in claim 8, wherein said object detecting unit includes a component detector operable to provide the alarm signal to said control unit when said storage component and said pump device are removed from said installation component, such that said control unit is operable to control said switch unit to disable supply of power from said power unit and thereby deactivate said transmission unit, and is operable to control said alarm unit to issue the notification.

11. The automatic liquid supply system as claimed in claim 8, wherein said object detecting unit includes a liquid level detector operable to provide the alarm signal to said control unit when amount of the liquid remaining in said storage component is less than a predetermined value, such that said control unit is operable to control said alarm unit to issue the notification.

12. The automatic liquid supply system as claimed in claim 8, wherein said object detecting unit includes a liquid flow control detector operable to provide a trigger signal to said control unit upon detecting approach of an object, such that said control unit is operable to control said pump device to allow a predetermined amount of the liquid in said internal space to flow out of said storage component through said internal passage.
